(19) United States
(12) Patent Application Publication
(10) Pub. No.: US 2005/0141784 A1
(43) Pub. Date: Jun. 30, 2005

(54) Image scaling using an array of processing elements

(76) Inventor: Rafael Maestre Ferriz, Irvine, CA (US)

Correspondence Address: Jon W. Hallman;MacPHERSON KWOK CHEN & HEID LLP, Suite 226, 1762 Technology Drive, San Jose, CA, 95110, US

(21) Appl. No.: 10/750,721

(22) Filed: Dec. 31, 2003

(51) Int. Cl. G06K 9/40; G06F 7/38

(52) U.S. Cl. 382/298; 708/290

(57) ABSTRACT

A technique to perform image scaling using an array of processing elements is provided. The pixel values in a video line are re-ordered such that when broadcast to the array of processing elements, they may each be processed according to the same multiply-and-accumulate coefficient set.

### FIELD OF INVENTION

This invention relates generally to digital signal processing, and more particularly to the scaling of digital images using an array of processing elements.

### BACKGROUND

Designers of modem digital signal processing systems have typically used application-specific integrated circuits (ASICs) or configurable devices such as ultra-high performance digital signal processing (DSP) circuits and programmable logic devices (e.g., field programmable gate arrays (FPGAs)) to implement their designs. Depending upon the desired application, a designer may select from ready-made “IP cores” that may be integrated into an ASIC relatively inexpensively as compared to the use of more costly configurable devices. However, once set into silicon, ASIC-based designs are fixed and cannot easily be changed in response to re-designs or other needed modifications. In contrast, the configurability of devices such as FPGAs allows a designer to more readily modify existing designs. Thus, a designer was faced with the dilemma of either using an ASIC to save costs but lose programmability or using a configurable device such as an FPGA to gain flexibility but bear increased manufacturing costs.

A third approach using an array of processing elements that can run in parallel may provide enough performance and flexibility to solve this dilemma. To simplify the computation model the array of processing elements could follow a single-instruction-multiple-data (SIMD) architecture. In general, each processing element may be dedicated to the performance of a desired task, such as a multiply-and-accumulate (MAC) operation. However, greater flexibility is provided in the single instruction multiple data (SIMD) architecture 5 shown in FIG. 1, wherein a user may program an array 7 of reconfigurable cells (RCs) 10 to perform the desired digital signal processing. Array 7 of RCs 10 is arranged in a row/column fashion. The number of rows and columns for array 7 of RCs 10 is arbitrary. Each RC 10 includes a multiply-and-accumulate (MAC) unit (not illustrated). In addition, optional functionalities within an RC 10 may include an arithmetic logic unit, conditional unit, as well as some specialized units, like a complex correlator and/or CDMA unit. Depending upon instructions delivered through a context (configuration) or instruction memory, that may be arranged into row context memory 15 and a column context memory 20, RCs 10 may be used for different digital signal processing operations, switching from one application specific set of instructions to another on a single clock cycle. Thus, unlike an array of dedicated processing elements, the array of RCs 10 may be configured by the user as necessary to meet the demands of a particular design. A processor 30, which may be a reduced-instruction-set (RISC) processor, determines what instructions are supplied to RCs 10 by context memory 20 through commands delivered to a direct memory access (DMA) controller 40. Depending upon their configuration, RCs 10 process data received from a frame buffer 50 over a bus 45. In addition to processing data received over bus 45, each RC 10 may be configured to access an output from internal register files (not illustrated) or outputs from other RCs 10 in the same row or column. Processor 30 and DMA controller 40 may couple to external processor and DMA memories (not illustrated).

To keep the hardware complexity within certain boundaries, there are usually some limitations to the data broadcast bandwidth and flexibility. Consequently, data from frame buffer 50 cannot be arbitrarily broadcast in any desired fashion to individual RCs 10. For example, consider the data broadcast scheme for an array 7 of sixteen reconfigurable cells arranged in 2 rows and 8 columns as shown in FIG. 2. In this embodiment, frame buffer 50 (FIG. 1) is limited to broadcasting 128 bits (16 bytes) of data to RCs 10 in any given clock cycle through a 128-bit wide bus 45. The bytes are broadcast consecutively: the first two bytes (16 bits) to the first column of reconfigurable cells, the next two bytes to the second column of reconfigurable cells, and so on. Within each column, the reconfigurable cells may be configured to select either the most significant or least significant byte. In this fashion, the manner in which input pixel data is placed in frame buffer 50 determines how the data is broadcast to RCs 10. In this particular example, the number of RCs 10 equals the numbers of bytes in bus 45.

Given such a broadcast scheme, the implementation of a finite impulse response (FIR) filter using RC array 7 of FIG. 2 is straightforward. Each MAC unit (not illustrated) within each reconfigurable cell is identically configured with the appropriate FIR coefficients. The reconfigurable cells are denoted as RCm,n depending upon their row (m) and column (n) position within the array. In every clock cycle, each reconfigurable cell may receive the appropriate data as broadcast from frame buffer 50 such that after a number of clock cycles equaling the number of taps (denoted by N_{Taps}), sixteen filter outputs zi+0 through zi+15 may be obtained from the sixteen RCs 10. For example, to perform a FIR on a digital signal x(i), frame buffer 50 broadcasts through bus 45 the 16 consecutive bytes (assuming each sample x(i) is 8 bits) for samples x(i−(N_{Taps}−1)), x(i−(N_{Taps}−1)+1), . . . , x(i−(N_{Taps}−1)+15) to RC₀₀, RC₁₀, . . . RC₁₇, respectively, whereupon each RC performs a MAC operation using the loaded coefficient set. At the next clock cycle, frame buffer 50 broadcasts another 16 consecutive bytes for samples x(i−(N_{Taps}−1)+1), x(i−(N_{Taps}−1)+2), . . . x(i−(N_{Taps}−1)+16) to RC₀₀, RC₁₀, . . . RC₁₇, respectively, whereupon each RC again performs a MAC operation using the loaded coefficient set (the identical coefficient sets may have to be updated unless every tap value is multiplied by the same value). This process continues, one MAC cycle for each tap value, until the final tap values of x(i), x(i+1), . . . , x(i+15) are broadcast to RC₀₀ through RC₁₇, respectively. After this final MAC cycle, RC₀₀ may provide output sample z(i), RC₁₀ may provide output sample z(i+1), and so on, until RC₁₇ provides output sample z(i+15). It should be noted that saturation to a given interval may also be performed.

Although frame buffer 50 may broadcast data to RC array 7 in a natural fashion to implement a FIR, the process becomes cumbersome should a SIMD array of processing elements such as RC array 7 be used to perform image scaling. Image scaling is used to change the resolution of images, typically frames of a video stream. In general, it will comprise using independent sets of filters on the video frames such that one independent set is used to generate the horizontal scaling and another independent set is used to generate the vertical scaling. The filtering carried out in either a horizontal or vertical scaling may be expressed in a general fashion as follows:

$${z}_{i} = {\sum }_{j = 0}^{Ntaps - 1} {c}_{j}^{k} {x}_{n + j} \qquad ( 1 )$$

where cⱼ^{k} is the j-th coefficient of set k, Nₜₐₚₛ is the number of taps in each coefficient set, and xₙ₊ⱼ is the input component at the (n+j)th pixel. This expression represents the filtering in only one dimension, the remaining dimension being assumed to remain constant. The integer values n and k depend upon the input to output width or height ratio and the actual position of the zᵢ output pixel within a particular video line. The values of Nₜₐₚₛ and Cⱼ^{k} do not necessarily have to be the same for both dimensions.

Application of equation (1) for an input-to-output width ratio of 3/8 and Nₜₐₚₛ equals to 16 may be described with respect to FIG. 3. In FIG. 3, input and output pixels are superimposed keeping the same total length, in such a way that the first and last input and output pixels coincide. Moreover, the pixels are regularly spaced between the first and last pixels. For this ratio of image scaling, the space between input pixels (marked by circles) is divided into Nₜₐₚₛ equal intervals, 16 in this case (from 0 to 15). Each interval uses a different coefficient set. The location of an output pixel (marked by plus signs) within a particular interval thus determines which coefficient set is used within equation (1) to generate the output pixel. For the summation in equation (1), a window of Nₜₐₚₛ input pixels centered about the output may be used.

As compared to the broadcast scheme for a FIR implementation discussed with respect to FIG. 2, a number of differences may be observed in implementing an image scaling using a SIMD array of processing elements such as RC array 7. For example, consider that output pixels z₀, z₁, and z₂ will all depend upon the same input pixel set. Each of output pixels z₀ through z₂ will map to an individual reconfigurable cell within RC array 7. However, frame buffer 50 cannot broadcast the same input pixel data to three reconfigurable cells. In addition, note that for any given collection of consecutive output pixels, different coefficient sets are required. This requires substantial overhead to load the different coefficient sets into the appropriate reconfigurable cells within RC array 7. Moreover, the factor (n-i) is not a constant value. Due to the lack of simple regularity, the total number of possible broadcast modes that may be needed to efficiently implement FIG. 2 for an arbitrary input to output resolution ratio could complicate the hardware enormously.

These differences present a major challenge to the implementation of an image scaler using an array of reconfigurable cells. Moreover, this problem will exist even if the array of processing elements are dedicated MAC units instead of being reconfigurable. Accordingly, there is a need in the art for improved techniques for the implementation of image scalers using arrays of processing elements.

### SUMMARY

In accordance with one aspect of the invention, a method of image scaling using an array of processing elements is provided, wherein the processing elements are arranged from a first processing element to an nth processing element, and wherein the image scaling uses a tap window size of N_{Taps}. The method includes the acts of: re-ordering the pixel values in a video line; loading a frame buffer with the re-ordered pixel values, the re-ordered pixel values being arranged in words having a width of n input pixel values; broadcasting N_{Taps} successive words from the loaded frame buffer to the array, wherein for each word, the input pixel values are arranged from a first input pixel value to an nth input pixel value such that, for each word broadcast to the array, the first processing element processes the first input pixel value in the word, the second processing element processes the second input pixel value in the word, and so on, and wherein the re-ordering of the pixel values is such that each processing element is configured to process the N_{Taps} input pixels it receives from the frame buffer into a scaled output pixel value using the same multiply-and-accumulate coefficient set. The description of this scaling method is provided for both dimensions, along with its relation.

### BRIEF DESCRIPTION OF THE DRAWINGS

FIG. 1 is a block diagram for an array of reconfigurable cells arranged in a SIMD architecture according to one embodiment of the invention.

FIG. 2 illustrates the data broadcast requirements for implementing a FIR filter in an embodiment of the SIMD architecture of FIG. 1 having sixteen reconfigurable cells.

FIG. 3 illustrates the relationship between input and output pixels for one embodiment of the invention.

FIG. 4 illustrates the input pixel data arrangement according to one embodiment of the invention.

FIG. 5 illustrates a data broadcast scheme for one embodiment of the invention having sixteen reconfigurable cells.

FIG. 6 illustrates an output pixel data arrangement according to one embodiment of the invention.

FIG. 7 illustrates a data broadcast scheme for one embodiment of the invention having sixteen reconfigurable cells.

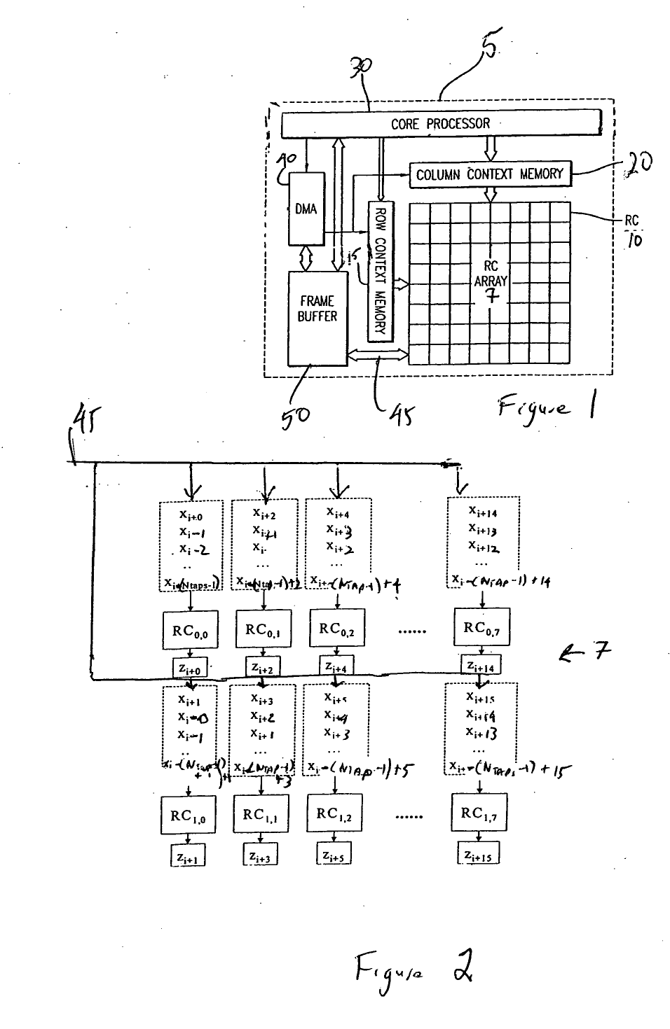

Use of the same reference symbols in different figures indicates similar or identical items.

### DETAILED DESCRIPTION

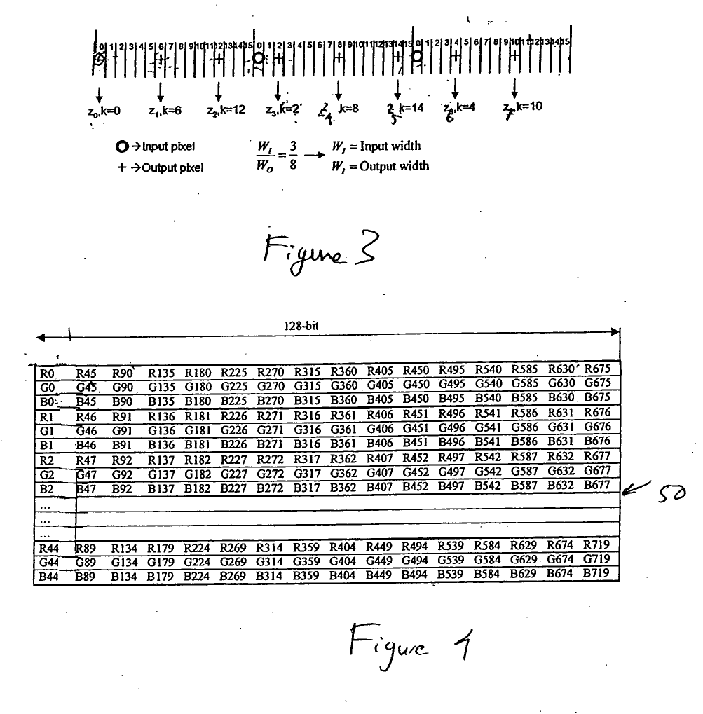

The following description of an image scaler implementation using an array of reconfigurable cells within a SIMD architecture will be described with respect to exemplary RC array 7 having sixteen reconfigurable cells denoted as RC₀₀ through RC₁₇ as shown in FIG. 2. However, it will be appreciated that the number of reconfigurable cells and their arrangement within RC array 7 is arbitrary and may be varied depending upon a user's needs. Moreover, the image scaler implementation discussed herein is widely applicable to any array of processing elements arranged in a SIMD architecture such as an array of dedicated multiply-and-accumulate (MAC) processing elements. Each processing element, whether reconfigurable or not, should be able to perform a MAC operation as required in an image scaler. Thus, it will be understood that the reconfigurable cells (RCs) in the following discussion could be replaced by dedicated MAC processing elements.

Regardless of the number of RCs within the array, RC array 7 may be considered to be arranged from a first RC to a last RC so that a corresponding restriction on how data is broadcast from frame buffer 50 may be specified with respect to the RC arrangement. For example, referring again to FIG. 2, RC₀₀ may be considered the first reconfigurable cell, RC₁₀ the second, RC₀₁ the third, and so on. Clearly, in any SIMD architecture, each RC should be able to receive data from a memory such as frame buffer 50 in any given clock/calculation cycle so that the parallel processing advantage provided by such an architecture may be fully utilized. Thus, the width of bus 45 between frame buffer 50 and an RC array will have a minimum data width of: (the number of RCs in the array) times (the RC input data width, which is typically a byte). With respect to FIG. 2, the width of data bus 45 will thus be 16 bytes. Just like the RCs, these 16 bytes will be considered to be arranged from a first byte to a last byte. The data broadcast restriction will be assumed to be the following: the first and second bytes may only be broadcast to the first and second RCs, the third and fourth bytes may only be broadcast to the third and fourth RCs, and so on. However, it will be appreciated that the present invention is not limited to implementing an image scaler under this specific data broadcast restriction. Indeed, those of ordinary skill in the art will appreciate that once a data broadcast restriction has been specified, the techniques disclosed herein may be used to implement an image scaler under such restrictions.

Image scaling according to the present invention may be performed first in the horizontal dimension and then in the vertical dimension. Alternatively, an image scaling may be performed first in the vertical dimension and then in the horizontal dimension. The order of image scaling execution influences some implementation trade-offs as will be discussed further herein. A horizontal dimension image scaling will be discussed first.

Horizontal Scaling

Referring again to FIG. 3, the input pixels (denoted by circles) and output pixels (denoted by plus signs) for an input width to output width ratio equaling 3/8 and Nₜₐₚₛ equals to 16 is illustrated. The space between input pixels is divided into Nₜₐₚₛ (16) equal intervals, from 0 to 15. Each interval uses a different coefficient set. The location of an output pixel within a particular interval thus determines which coefficient set is used within equation (1) to generate the output pixel. Inspection of FIG. 3 reveals that the coefficient set pattern will repeat itself should the figure have been expanded. In other words, had the figure included the next three input pixels and the corresponding eight output pixels, the coefficient set pattern of 0, 6, 12, 0, 2, 8, 14, 4, and 10 would repeat. Thus, output pixel z₈ would use coefficient set 0 (just like pixel z0), output pixel z₉ would use coefficient set 6 (just like pixel z₁), and so on.

This repetition of the required coefficient sets is exploited in the following fashion. The input pixels (assumed to be 8 bits each) within each 128 bit word that will be broadcast by frame buffer 50 over bus 45 to RC₀₀ through RC₁₇ are arranged such that in any given MAC iteration/calculation cycle, each RC will be using the same coefficient set. In turn, the arrangement of input pixels within each 128 bit word will depend upon the particular output pixel an RC is producing. For example, should the arrangement of input pixels in frame buffer 50 be such that RC₀₀ processes output pixel z₀ and RC₁₀ processes pixel z₆₄, both these reconfigurable cells would be configured to use the same coefficients at each MAC iteration. The input pixels values would be loaded into frame buffer 50 such that at each MAC iteration (MAC calculation cycle), the corresponding input pixel values would be broadcast to RC₀₀ and RC₁₀ as appropriate in the generation of pixel values z₀ and Z₆₄. In general, arranging the input pixels in frame buffer 50 such that each MAC iteration for the RC array uses the same coefficient set may be done in a number of ways and depends upon the input to output width ratio. However, if both the input pixel width and the output pixel width are multiples of the RC array size (wherein the array size is denoted by an integer M), it may be shown that a data broadcast scheme in which the input pixels are arranged in frame buffer 50 according to increments of a factor Nᵢ=input width/M such that that the output pixels from the RC array are incremented by a factor Nₕ=output width/M will always be valid, regardless of the particular input to output width ratio being used.

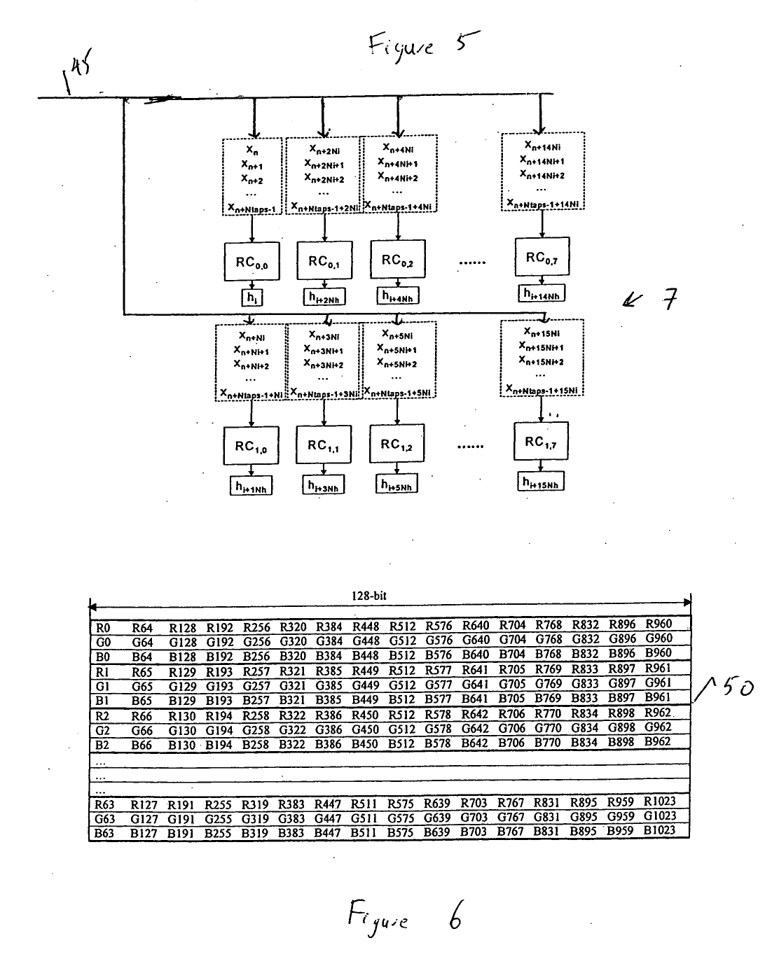

For example, consider the corresponding input pixel data placement for an input width of 720 and an array size M of sixteen as illustrated in FIG. 4. In this example, the image format uses red, green, and blue components but the same approach is valid if a different image format such as luminance and chrominance is adopted. Inspection of FIG. 4 shows that the first 128 bit word having red input pixels R0, R45, R90, and so on, such that the appropriate increments of Nᵢ=720/16=45 are implemented when this word is broadcast to the reconfigurable cells. Frame buffer 50 would be configured to increment by 48 bytes for every word broadcasted so that the 128 bit word having red input pixels R1, R46, R91, and so on would be broadcast at the next MAC iteration. In general, the increment between words broadcast to the RC array will equal the product of the number of components within the image format and the frame buffer width. Each component of the image format such as red, green, or blue should be processed independently in this fashion. If the resolution of the different components is not equal (i.e. in 4:2:0 YUV format), the increment could be easily computed from those resolutions and the bus width.

The scrambling of an input pixel line into the required order before loading into frame buffer 50, such as the scrambled 720 input pixel video line shown in FIG. 4 may be performed in hardware or software. The construction of a means to provide the necessary scrambling is well-known in the art.

Referring back to FIG. 2, it can be seen that there are no input pixels to the left of pixel z₀ because this pixel is at the image boundary. However, if the tap window N_{Taps} (the number of input pixel values used in the summation of Equation (1)) is centered about each output pixel, there would be input pixels missing within such a window for pixel z₀ and the last pixel in the video line. Similarly, depending upon the size of N_{Taps}, additional pixels adjacent to z₀ and the last pixel in the video line would also have missing input pixels within their tap windows. For a centered tap window, the number of adjacent pixels at the image boundary that would have missing pixels would be approximately N_{Taps}/2. These missing pixels may be assumed to have a value of zero. Thus, with respect to the data placement shown in FIG. 4, frame buffer 50 may be padded with additional 16-byte rows of zeroes immediately before the first frame buffer row. If an eight-pixels-wide centered tap window is used, four zero-loaded rows may be added for each image component. For an RGB image format, 12 zero-loaded rows would thus suffice. A similar problem exists at the other edge of the image. However, assuming a circular buffer arrangement, the same zero-loaded rows may be used both image edges. By adding these zeroes to frame buffer 50, a similar code structure could be used for processing of all the pixels in the video line. If no zeroes are added to frame buffer 50, the output pixels close to the line boundaries have to be considered as special cases, introducing some irregularities in the implementation.

The resulting data broadcast scheme for a given set of sixteen output pixels is shown in FIG. 5, where the nth input pixel is denoted by xₙ and the ith output pixel is denoted by hᵢ. Inspection of FIG. 5 demonstrates that each output pixel increments by the factor Nₕ for successive RCs as discussed. In addition, the input pixels increment by the factor Nᵢ for successive RCs as well. Typically, either the entire image or at least Nₜₐₚₛ consecutive video lines are horizontally scaled before the vertical scaling begins. However, in general it is enough to generate Nₜₐₚₛ portions of different consecutive lines. This would imply different memory/performance trade-offs.

During each MAC iteration, 16 input pixel values are broadcast to the respective sixteen reconfigurable cells. The tap window size Nₜₐₚₛ determines the number of MAC iterations that are necessary to complete a MAC calculation cycle so that an output pixel values may be produced by each RC. Upon completing the MAC calculation cycle and thus producing 16 pixel output values, the RC array may broadcast the pixel output values back to frame buffer 50. The generation of addresses for reading or storing data from frame buffer 50 could be implemented either in hardware (by using an address generation unit) or software. The ones implemented in software, could be computed once and stored in memory for later use.

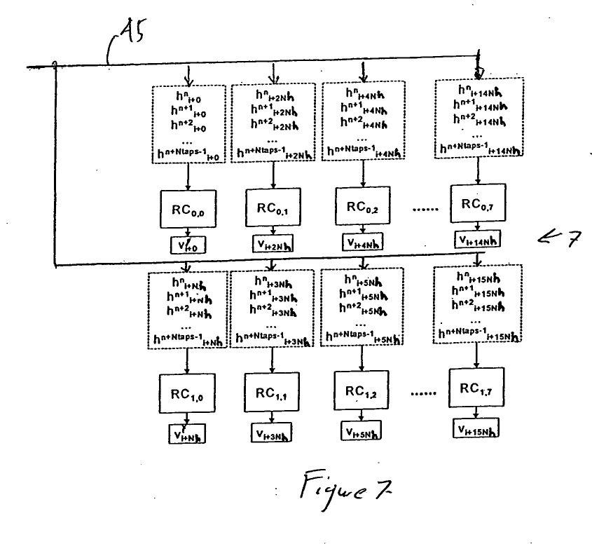

The resulting data arrangement within frame buffer 50 is shown in FIG. 6. As expected, within each frame buffer word of 128 bits, the pixel value increments by 64 pixel positions (Nₕ=1920/16=64). For example, in the first line, the red pixel outputs increment from position 0 to 64, and then to 128, and so on.

Once a coefficient set has been loaded to the RCs 10, it is possible to generate all the output pixels that use the same coefficient set consecutively, before the next coefficient set is loaded. This would minimize the number of coefficient set loadings. Thus, for example, after calculating the frame buffer word R0, R45, R90, . . . , R675 shown in FIG. 4, the frame buffer word R8, R53, R98, . . . , R673 (not illustrated) would be generated. It follows that there would be two pointer increments with respect to word broadcasts from frame buffer 50 of FIG. 4: one pointer increment between MAC iterations (the 48 byte increment discussed previously) and another pointer increment between MAC calculation cycles. Different components could be generated one after another or in an interleaved fashion. In the interleaved generation, the pointer increment between MAC iterations could be 16 bytes. However, consecutive back-to-back MACs will correspond to different components (i.e. R, G and B). In this case, multiple registers may be required to store the multiple on-going MAC accumulations.

Vertical Scaling

Vertical scaling involves the weighted summing of input pixels from different video lines. Thus, although conceptually similar to horizontal scaling, the data broadcast scheme will be necessarily different than that just discussed for horizontal scaling. Scaling in the vertical dimension will also demonstrate a coefficient repetition pattern. For example, consider an output pixel produced by Equation (1). In a vertical scaling, the tap window is centered (assuming a centered window) about the output pixel's video line. The input pixels come from immediately neighboring video lines. Independently of the image resolution, the necessary coefficient set cⱼ^{k} will be the same for output pixels on the same video line. This coefficient set will be repeated for a subset of the remaining video lines in a manner similar to that discussed with respect to FIG. 3.

The resulting data broadcast for an array of sixteen RCs is illustrated in FIG. 7. The data broadcast resulting from an initial horizontal scaling for an array of sixteen RCs is illustrated in FIG. 7. This would be the input data placement for vertical scaling. Pixels on the same frame buffer row are separated by Nₕ=output width/M. Output pixel values are represented by the letter v. The subscript for each v identifies its pixel position within the corresponding video line. Input pixel values are identified by the letter h having a subscript that also identifies their horizontal position within their video lines. Because this is a vertical scaling, the input pixel set to each processing element RC 10 necessarily has the same horizontal location. However, these input pixels will originate from successive video lines as identified by their superscript. Zero values will be used for scaling at the image edges as discussed with respect to FIG. 4.

If vertical scaling is performed first, it is possible to store the output pixel values within internal registers in the RCs 10. In this fashion, vertical scaling may be executed first without requiring the output pixel values be saved to frame buffer 50. However, because the register storage is limited, only a portion of the image could be processed at any given time in this fashion. It will be appreciated that saturation of the output pixel values may be necessary to ensure there is no overflow in the pixel values. Assuming each output pixel is 8-bits wide and the internal registers within each RC 10 are 16-bit registers, it would be possible to skip any necessary saturation processing for the output of the vertical scaler if it is performed before the horizontal scaling. The saturation processing could also be skipped if the horizontal scaling is done first; however, it would require spending more time saving 16-bit values vs. storing just 8-bit values.

General Data Placement

As discussed above, both the horizontal scaling and the vertical scaling may be performed in a straightforward fashion should the input width and output width all be multiples of the array size. Because input and output resolutions are typically multiples of 16, using an array size of sixteen RCs is particularly convenient. But there may be scaling applications in which these factors are not multiples of the array size. One solution would be to add zeroes to each video line such that the input width and/or the output width are multiples of the array size. However, such an approach will introduce some error into the resulting image scaling. Alternatively, the ratio of the input width to the output width could be reduced such that numerator and the denominator are the smallest integer numbers. In this fashion, the smallest “Nₕ” factor that does not produce any errors may be derived. But because this factor is not necessarily a multiple of the array size, not all the reconfigurable cells would be used at every iteration, thereby wasting processing power.

To avoid any waste of processing power or image error introduction, the following approach may be used when the input width and/or the output width are not multiples of the array size. Instead of considering only one input video line, “p” input lines may be used, wherein the products of (p*input width) and (p*output width) are both multiples of the array size (p being a positive integer). Then the following expressions would be used to calculate factors Nᵢ and Nₕ: Nᵢ=(p*Wᵢ)/M and Nₕ=(p* Wₕ)/M, where Wᵢ denotes the input width, Wₕ denotes the output width, and M denotes the number of RCs 10 within array 7.

The same number of pixels from each of the p video lines will be broadcast to RC array 7 simultaneously. The output will be generated in accordance to the input data broadcast and Nₕ value. Although any integer value of p may be used, to reduce the memory requirements, it is desirable to use the minimum possible integer value for p. This number is directly proportional to the memory size, since p means the number of video lines that need to be buffered to process scaling.

Consideration of Generic Array and Bus Sizes

It was previously mentioned that the number of RCs 10 matches the number of bytes in the bus 45. However, the present invention can be generalized in this regard, while using the proposed data placement (FIGS. 4 and 6). The RC array 7 can be divided into sets, so that the number of RCs 10 within each set times the input data width for each RC 10 is equal to (or smaller than) the bus width. Then, the bus is connected in such a way that at least one RC 10 in every set receives the same input data. This implies that the same data broadcast represented in FIG. 5 could be obtained in any of the sets of RCs.

From FIG. 3, it can be seen that consecutive outputs z₃, z₄ and z₅ are using the same set of inputs. Consequently, if the corresponding coefficients are loaded into three different RC sets, outputs z₃, z₄, and z₅ could be generated totally in parallel. By extension, different RCs 10 within each RC set will generate outputs separated by Nₕ, as shown in FIG. 5. As previously mentioned, to minimize the coefficient movement overhead, all the outputs using the same coefficient set will be processed, before reloading the next sets of coefficients.

In general, the processing of consecutive outputs is allocated to different RC sets. It is better to keep together the outputs that are using the same set of inputs, but sometimes this is not possible. In this case, the RC sets should avoid the processing of some input data that is used by other RC sets. For example, if we assume 4 coefficient sets and outputs z₄, z₅, z₆ and z₇ in FIG. 3, the first input will be processed to generate z₄ and z₅, but we should not use these data to generate z₆ and z₇. Similarly, there will be one input that is used by z₆ and z₇ but not by z₄ and z₅. If the hardware does not allow to selectively disable some of the RC sets, additional coefficients with zero value could be loaded to be used during the undesired data broadcast.

Image scaling using a generic array and bus width size may thus be performed in a number of fashions depending upon the spatial relationship of the input and output pixels as discussed with respect to FIG. 3. For example, with respect to FIG. 3, the output pixels may be arranged into three sets, each set being generated using a corresponding set of input pixels: a first set of output pixels z₀, z₁, and z₂, a second set of output pixels z₃, z₄, and z₅, and a third set of output pixels z₆ and z₇. RCs 10 may then be subdivided into three sub-arrays: RC set 0, RC set 1, and RC set 2. To generate the first set of output pixels, RC set 0 would be loaded with coefficient set k=0, RC set 1 loaded with coefficient set k=6, and RC set 2 loaded with coefficient set k=12. After the broadcast of Nₜₐₚₛ input pixels to each RC set, RC set 0 would provide z₀, z_{0+Nh}, . . . , RC set 1 would provide z₁, z_{1+Nh}, . . . , and RC set 2 would provide z₂, z_{2+Nh}, . . . . As discussed above the remaining output pixels that require these coefficient sets may then be calculated without requiring any additional coefficient loading. After all such output pixels are calculated, RC set 0 may be loaded with the k=2 coefficient set, RC set 1 may be loaded with the k=8 coefficient set, and RC set 2 may be loaded with the k=14 coefficient set. Then all output pixels requiring these coefficient sets, such as output pixels z₃, z₄, and z₅, respectively, may be calculated. Finally, two of the RC sets, such as RC set 0 and RC set 1, may be loaded with coefficient sets k=6 and k=7, respectively, so that all pixel values such as z₆ and z₇ corresponding to these coefficient sets may be calculated.

Although the previous scheme provided a broadcast scheme for a generic array and bus size, note that the final coefficient loading scheme used only two of the available sets of RCs 10. A more efficient implementation would thus use just two RC sets as follows. The RC sets may be denoted as RC set 0 and RC set 1 as before. The output pixels would be paired to correspond to the two sets. For example, output pixels z₀ and z₁ each use the same coefficient set. Similarly, output pixels z₂ and z₃ almost use the same input pixel set such that only the first input pixel for the calculation of z₂ is not used in the calculation of z₃ and that the last input pixel for the calculation of z₃ is not used in the calculation of z₂. Output pixels z₄ and z₅ use the same input pixel set. Finally, output pixels z₆ and z₇ use the same input pixel set.

Following this pattern, all the output pixels that share the same coefficient sets may be calculated. For example, RC sets 0 and 1 may be loaded with the k=0 and k=6 coefficient sets, respectively, to generate output pixels z₀, z₁, z₈, z₉, etc. Similarly, RC sets 0 and 1 may be loaded with the k=12 and k=2 coefficient sets to generate output pixels z2, z3, z10, z11, etc. However, note that during these calculations, Nₜₐₚₛ+1 input pixel values must be broadcast having the overlap discussed above. The remaining coefficient set pairs of (k=8, k=14) and (k=4, k=10) may then be used to generate the remaining output pixel values.

The above-described embodiments of the present invention are merely meant to be illustrative and not limiting. It will thus be obvious to those skilled in the art that various changes and modifications may be made without departing from this invention in its broader aspects. For example, the array size is arbitrary and may be varied according to design needs. Accordingly, the appended claims encompass all such changes and modifications as fall within the true spirit and scope of this invention.

1. A method of image scaling using an array of processing elements, wherein the processing elements are arranged from a first processing element to an nth processing element, and wherein the image scaling uses a tap window size of Nₜₐₚₛ, the method comprising:
(a) loading a frame buffer with pixel values from a video line, the pixel values in the loaded frame buffer being arranged into words having a width of n input pixel values; and
(b) broadcasting Nₜₐₚₛ words from the loaded frame buffer to the array, wherein for each word, the input pixel values are arranged from a first input pixel value to an nth input pixel value such that, for each word broadcast to the array, the first processing element processes the first input pixel value in the word, the second processing element processes the second input pixel value in the word, and so on, and wherein the broadcast order of the pixel values is such that each processing element is configured to process the N_{Taps} input pixels it receives from the frame buffer into a scaled output pixel value using the same multiply-and-accumulate coefficient set, the processing elements thereby producing an output word of n scaled pixel values.

2. The method of claim 1, further comprising:
vertically-scaling pixels from a set of video lines to produce scaled pixel values for the video line, wherein the pixel values loaded into the frame buffer in act (a) are the vertically-scaled pixel values, and wherein the scaled output pixel values from each processing element in act (b) are both horizontally-scaled and vertically-scaled output pixel values.

3. The method of claim 1, further comprising:
(c) repeating act (b) to produce a succession of output words from the array of processing elements, wherein the succession of output words represents a horizontally-scaled version of the video line.

4. The method of claim 3, further comprising:
repeating acts (a) through (c) to produce a succession of output words for a plurality of horizontally-scaled video lines;
storing the output words in the frame buffer for the plurality of scaled video lines
successively broadcasting sets of pixel values from the plurality of scaled video lines stored in the frame buffer to the array of processing elements; and
processing the sets of pixel values in the array of processing elements to produce a set of vertically-scaled output words.

5. The method of claim 4, further comprising:
re-ordering the vertically-scaled output words to provide a horizontally and vertically scaled video line.

6. The method of claim 1, wherein the number of input pixel values in the video line is an integer multiple Nᵢ of n, and wherein the number of output pixel values in a scaled video line is an integer multiple Nₕ of n, the broadcast order in act (b) being every Nᵢth input pixel, the scaled output pixel values from each multiply-and-accumulate calculation cycle being spaced apart by Nₕ pixel values.

7. The method of claim 1, wherein the number of input pixel values in the video line is not an integer multiple of n.

8. The method of claim 4, wherein the number of output pixel values in each scaled video line is not an integer multiple of n.

9. The method of claim 1, further comprising:
loading the frame buffer with padded video lines comprised of zero values, wherein when act (b) calculates output pixel values using input pixel values that are outside of the video line, zero values from the padded video lines are used.

10. An image processor, comprising:
an array of processing elements arranged from a first processing element to an nth processing element;
a frame buffer storing input words of n pixel values in length, the image processor being configured such that input words from the frame buffer may be successively broadcast to the array of processing elements, wherein the first processing element receives the first pixel value from a broadcast input word, the second processing element receives the second pixel value from the broadcast input word, and so on, the processing elements being configured to perform multiply-and-accumulate (MAC) operations on the received values such that after the broadcast of Nₜₐₚₛ words from the frame buffer, each processing element may provide a scaled output pixel value using the same MAC coefficient set, the array of processing elements thereby producing an output word of n scaled output pixel values.

11. The image processor of claim 10, wherein the image processor is configured such that the output word may be stored in the frame buffer.

12. The image processor of claim 10, wherein the output word is a horizontally-scaled output word.

13. The image processor of claim 10, wherein the output word is a vertically-scaled output word.

14. The image processor of claim 10, wherein the input words are vertically-scaled words and the output words are both horizontally and vertically scaled words.

15. The image processor of claim 10, wherein the input words are horizontally-scaled words and the output words are both horizontally and vertically scaled words.

16. The image processor of claim 10, further comprising one or more additional arrays of processing elements, the frame buffer being arranged to successively broadcast input words to the one or more additional arrays such that the one or more additional arrays may also each provide an output word of scaled pixel values, wherein each scaled pixel value in the output word from the one or more additional arrays is calculated using the same multiply-and-accumulate coefficient set.

17. The image processor of claim 10, wherein the processing elements are reconfigurable processing elements.
